(19) United States
(12) Patent Application Publication
(10) Pub. No.: US 2020/0318404 A1
(43) Pub. Date: Oct. 8, 2020

(54) Magnetic Doorstop

(71) Applicant: Leon Rashed, San Pablo, CA (US)

(72) Inventor: Leon Rashed, San Pablo, CA (US)

(21) Appl. No.: 16/376,684

(22) Filed: Apr. 5, 2019

(51) Int. Cl. E05C 19/00; E05C 17/44

(52) U.S. Cl. CPC E05C 19/004; E05Y 2900/132; E05C 17/44; E05C 19/005

(57) ABSTRACT

A magnetic doorstop. The magnetic doorstop includes a plate that can be mounted on a surface, such as a door. An arm extends from the plate at a hinge and can be pivoted about the hinge such that the arm can occupy an up position and a down position. A first end of the arm engages with a floor in the down position. While engaged with the floor, the first end of the arm prevents the door from moving. A magnet is disposed on the plate in line with the arm. The arm can magnetically secure to the plate in the up position.

### BACKGROUND OF THE INVENTION

The present invention relates to doorstops. Specifically, it relates to mountable doorstops that uses magnetic attraction to secure the doorstop in the up position.

Many people use doorstops in order to keep a door open without needing to hold it in place. Frequently, doorstops lose traction on the floor leading the door to close unexpectedly, such as when someone walks by displacing the floor slightly around the doorstop. Additionally, doorstops don't always remain in the desired position. Disengaging a doorstop from the floor only to have the doorstop swing back down preventing the door from closing can be frustrating. Therefore, a doorstop device that securely engages with the floor in the down position and magnetically secures to remain in the up position is needed.

In light of the devices disclosed in the known art, it is submitted that the present invention substantially diverges in design elements from the known art and consequently it is clear that there is a need in the art for an improvement to existing magnetic doorstops. In this regard, the instant invention substantially fulfills these needs.

### SUMMARY OF THE INVENTION

In view of the foregoing disadvantages inherent in the known types of magnetic doorstops now present in the prior art, the present invention provides a magnetic doorstop wherein the same can be utilized for providing convenience for the user when maintaining a door in an open position.

The present system comprises a magnetic doorstop having a plate that is configured to mount on a surface, such as a door, wherein an arm extends from the plate at a hinge. The arm is configured to pivot about the hinge, such that it can transition from an up position and a down position. In the down position, a first end of the arm engages with a floor, whereas in the up position the arm rests parallel to the plate. A magnet is disposed on the plate in line with the arm such that the arm magnetically secures to the plate in the up position. In some embodiments, the first end of the arm comprises a high friction tip. In another embodiment, a lower end of the high friction tip is configured to rest flush against the floor. In other embodiments, the plate comprises a bell-shaped cross section. In yet another embodiment, the hinge comprises a pin having an ovoid shape. In some embodiments, the plate further comprises at least one aperture configured to receive a fastener therethrough. In another embodiment, the arm rests flush against the plate when in the up position. In other embodiments, the magnet is disposed within the plate.

### BRIEF DESCRIPTION OF THE DRAW NGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

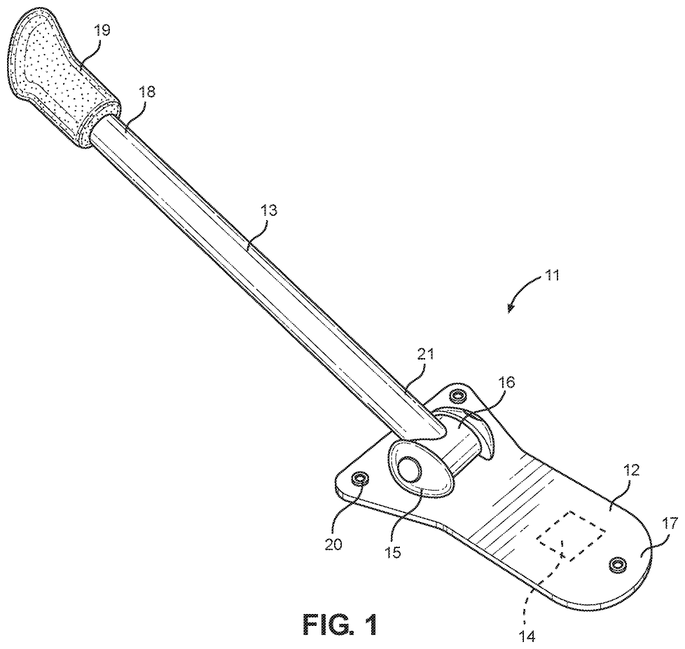

FIG. 1 shows a perspective view of an embodiment of the magnetic doorstop.

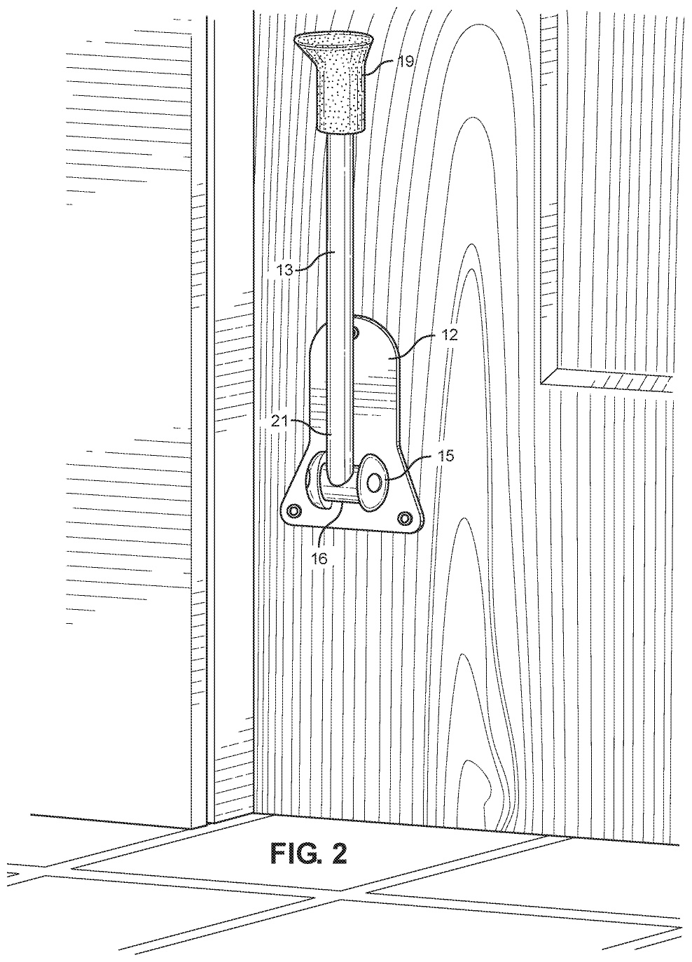

FIG. 2 shows a perspective view of an embodiment of the magnetic doorstop affixed to a door in the up position.

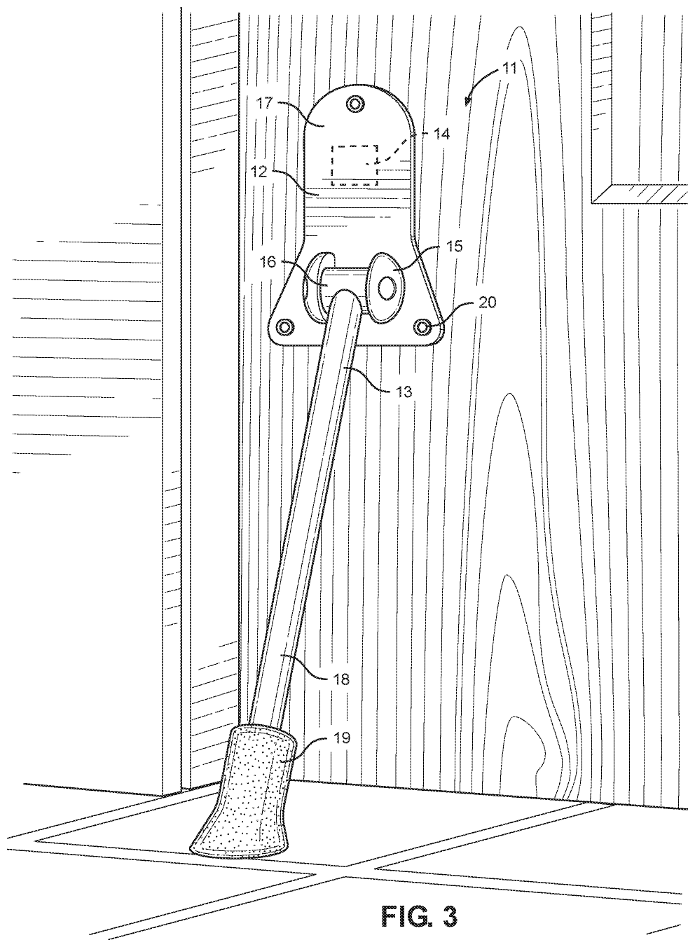

FIG. 3 shows a perspective view of an embodiment of the magnetic doorstop affixed to a door in the down position.

### DETAILED DESCRIPTION OF THE INVENTION

Reference is made herein to the attached drawings. Like reference numerals are used throughout the drawings to depict like or similar elements of the magnetic doorstop. The figures are intended for representative purposes only and should not be considered to be limiting in any respect.

Referring now to FIG. 1, there is shown a perspective view of an embodiment of the magnetic doorstop. The magnetic doorstop 11 comprises a plate 12 configured to mount to a surface, such as a door. In the illustrated embodiment, the plate 12 comprises a bell shape having a rounded upper end 17. The rounded upper end 17 allows the plate 12 to brace against the surface it is mounted on when the magnetic doorstop 11 is moved from one position to another, reducing stress on the magnetic doorstop 11 and spreading the force evenly across the entire surface area of the plate 12. This reduces the risk of any damage to the surface the plate 12 is mounted on when manipulating he magnetic doorstop 11. In the illustrated embodiment, the plate 12 further comprises at least one aperture 20 configured to receive a fastener therethrough, such that the plate 12 can be mounted on a surface. The plate 12 further comprises a magnet 14 disposed centrally on the upper end 17 such that it rests in line with an arm 13. In the illustrated embodiment, the magnet 14 is disposed within the plate 12 such that the plate 12 comprises a uniform appearance on the surface. In some embodiments, the magnet 14 is disposed on a front surface of the plate 12. In another embodiment, the magnet 14 is disposed on a rear surface of the plate 12.

The magnetic doorstop 11 further comprises an arm 13 extending from the plate 12 about a hinge 15. The arm 13 is configured to pivot about the hinge 15 such that the arm 13 transitions between an up position and a down position. A first end 18 of the arm 13 is configured to engage with a floor when in the down position. In the illustrated embodiment, a high friction tip 19 is disposed on the first end 18 of the arm 13. The high friction tip 19 is configured to engage with the floor when the arm 13 is in the down position, such that a door that the plate 12 is mounted on cannot open. The high friction tip 19 serves to provide an increased surface area in contact with the floor while reducing the risk of any damage to the floor. In the illustrated embodiment, a lower end 23 of the high friction tip 19 is shaped such that it rests flush with the floor. Additionally, the shape of the high friction tip 19 tapers towards a forward end of the high friction tip 19.

In some embodiments, the arm 13 comprises an angle such that the first end 18 and a second end 21 lie in different planes. The arm 13 is configured to removably secure to the plate 12 via magnetic attraction to the magnet 14 when in the up position. In some embodiments, the arm 13 rests flush with the plate 12 when the arm 13 is in the up position. This provides the magnetic doorstop 11 with a compact form factor when in the up position, reducing the risk of a user tripping over the arm 13. In some embodiments, the length of the arm 13 comprises a ferrous material, such that the entirety of the arm 13 is configured to magnetically secure to the plate 12. In another embodiment, a portion of the arm 13 comprises a ferrous material, wherein the portion is disposed such that it aligns with the magnet 14. In the illustrated embodiment, the arm 13 is configured to rotate 180 degrees relative to the plate 12 and is prevented from extending beyond the plane of the plate 12.

The arm 13 extends from the plate 12 such that it pivots about the hinge 15. In the illustrated embodiment, the hinge 15 comprises a pin 16, wherein the pin 16 comprises an ovoid shape. The ovoid shape of the pin 16 provides an increased coefficient of friction between the pin 16 and the plate 12 when the arm 13 is pivoted between the up position and the down position. This increased coefficient of friction allows the arm 13 to remain in the desired position. Additionally, the increased force required to move the arm 13 between the up position and the down position due to the ovoid shape of the pin 16 is evenly distributed across the plate 12 to reduce damage to the surface the magnetic doorstop 11 is mounted on. In the illustrated embodiment, the hinge 15 is disposed on a lower side of the plate 12, such that the hinge 15 is disposed on a wider end of the bell-shaped plate 12.

Referring now to FIGS. 2 and 3, there is shown a perspective view of an embodiment of the magnetic doorstop affixed to a door in the up position and a perspective view of an embodiment of the magnetic doorstop affixed to a door in the down position, respectively. In the illustrated embodiment of FIG. 2, the magnetic doorstop 11 is mounted on a door 22 in the up position. In the up position, the arm 13 removably secures to the magnet 14 such that the arm 13 rests flush with the plate 12. This minimizes the risk of a user tripping over the arm 13 when in use. In some embodiments, the arm 13 rests parallel to the plate 12. In the illustrated embodiment of the FIG. 3, the arm 13 is in the down position such that the firstend 18 engages with the floor. The high friction tip 19 is disposed on the first end 18 and increases the friction between the arm 13 and the floor such that the door resists being opened or closed as the user desires. The high friction tip 19 additionally reduces any possible damage to the floor.

In one use, a user installs the magnetic doorstop 11 on either side of a door as desired. If mounted as illustrated in FIGS. 2 and 3, the magnetic doorstop 11 serves to prevent a door from opening, however, if installed on the opposing side of the door, the magnetic doorstop 11 can serve to maintain a door in an open position. The magnetic doorstop 11 is installed by mounting the plate 12 to the door. In the illustrated embodiments, this is done by inserting a fastener through the apertures 20 and into the door. When the user desires to hold a door open or prevent the door from being opened, the arm 13 is pivoted about the hinge 15 such that the high friction tip 19 is engaged with the floor. The force required to move the arm 13 is increased due to the ovoid shape of the pin 16, however the force of the movement is evenly distributed about the plate 12 such that the door it is mounted on is not damaged. Once engaged with the floor, the high friction tip 19 prevents the door from moving. When the user wants to move the door from the position it is held in, the arm 13 is raised and removably secured to the magnet 14 such that the arm 13 is flush with the plate 12.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A magnetic doorstop, comprising:
a plate configured to be mounted to a surface;
an arm pivotally secured to the plate about a hinge such that the arm transitions between an up position and a down position;
wherein a first end of the arm is configured to engage with a floor in the down position;
a magnet disposed on the plate in line with the arm;
wherein the arm is configured to removably secure to the plate via magnetic attraction.

2) The magnetic doorstop of claim 1, further comprising a high friction tip disposed at the first end.

3) The magnetic doorstop of claim 2, wherein a lower end of the high friction tip is shaped to rest flush against the floor.

4) The magnetic doorstop of claim 1, wherein the plate comprises a bell-shaped cross section.

5) The magnetic doorstop of claim 1, wherein the hinge comprises a pin having an ovoid shape.

6) The magnetic doorstop of claim 1, wherein the plate further comprises at least one aperture configured to receive a fastener therethrough.

7) The magnetic doorstop of claim 1, wherein the arm rests flush against the plate when in the up position.

8) The agnetic doorstop of claim 1, wherein the magnet is disposed within the plate.
